(19) United States
(12) Patent Application Publication
(10) Pub. No.: US 2020/0400267 A1
(43) Pub. Date: Dec. 24, 2020

(54) Magnetic Socket Mount

(71) Applicant: Gerardo Garza, Houston, TX (US)

(72) Inventors: Gerardo Garza, Houston, TX (US); Jay Motley, Katy, TX (US)

(21) Appl. No.: 16/905,608

(22) Filed: Jun. 18, 2020

Related U.S. Application Data
(60) Provisional application No. 62/863,082, filed on Jun. 18, 2019.

(51) Int. Cl. F16M 11/04; H04M 1/04

(52) U.S. Cl. CPC F16M 11/041; F16M 13/022; H04M 1/04

(57) ABSTRACT

The present invention is a magnetic cover that may be fitted onto an electronic device to facilitate hands free utilization. The magnetic cover comprises a cover with magnets secured into the cover by a plate. The magnetic cover may fit around existing mounts, including collapsible mounts, or mount directly to the electronic device through various attachment means.

### CROSS-REFERENCES TO RELATED APPLICATIONS

This application claims the benefit of and priority to U.S. Provisional Application No. 62/863,082, filed Jun. 18, 2019, entitled “Magnetic Socket Mount.” This application is incorporated by reference.

### STATEMENT REGARDING FEDERALLY SPONSORED RESEARCH OR DEVELOPMENT

Not applicable.

### BACKGROUND OF THE INVENTION

### 1. Field of the Invention

This invention relates to electronic device accessories, and more particularly, to a magnetic mount attachable to the back of an electronic device to permit placement of the electronic device on metal surfaces. This allows users to have easy, usable, hands free access to and storage of the device and be able to utilize the device more effectively and safely.

### 2. Description of the Related Art

The prior art is embodied by the invention disclosed by U.S. Pat. No. 8,560,031. The product disclosed in the '031 patent utilizes adhesive to stick to the back of a phone or phone case and is not readily removable. Furthermore, the prior art, as disclosed in the '031 patent must be held by an individual and cannot be removably attached to other materials.

### SUMMARY OF THE INVENTION

The present invention includes multiple embodiments that permit a user to attach a cover, containing magnets, to the back of an electronic device to allow the electronic device to be magnetically coupled to a metallic surface. This invention permits hands free use of the device. This invention further may be utilized with other types of mounts such as collapsible mounts to permit hands free use, removable mounting to metallic surfaces, and the ability to allow the device to stand in a landscape or portrait orientation.

### BRIEF DESCRIPTION OF THE SEVERAL VIEWS OF THE DRAWINGS

FIG. 1 is a bottom up exploded view of a first embodiment.

FIG. 2 is a top down exploded view of a first embodiment.

FIG. 3 is a side view of a first embodiment.

FIG. 4 is a cross section view of line 4-4 from FIG. 3.

FIG. 5 is a top down exploded view of a second embodiment.

FIG. 6 is a bottom up exploded view of a third embodiment.

FIG. 7 is a bottom up exploded view of a fourth embodiment.

FIG. 8 is a top down view of a fourth embodiment.

FIG. 9 is a top down view of a fifth embodiment.

FIG. 10 is a side view of a fifth embodiment.

FIG. 11 is a cross section view of line 11-11 from FIG. 10.

FIG. 12 is a first configuration of an embodiment with an electronic device.

FIG. 13 is a second configuration of an embodiment with an electronic device.

FIG. 14 is a third configuration of an embodiment with an electronic device.

FIG. 15 is a fourth configuration of an embodiment with an electronic device.

FIG. 16 is a bottom view of a portion of the fifth and sixth configurations of an embodiment with an electronic device.

FIG. 17 is a top view of a portion of the fifth and sixth configurations of an embodiment with an electronic device.

FIG. 18 is a fifth configuration of an embodiment with an electronic device.

FIG. 19 is a side view of a sixth embodiment.

FIG. 20 is a cross section view of line 20-20 from FIG. 19.

FIG. 21 is a perspecitve view of a sixth embodiment.

FIG. 22 is a sixth configuration of an embodiment with an electronic device.

### DETAILED DESCRIPTION OF THE INVENTION

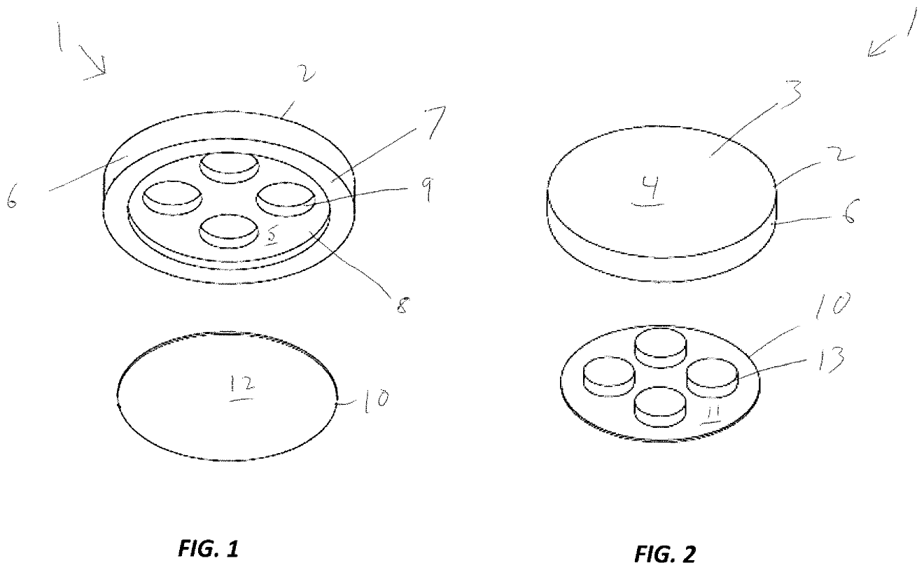

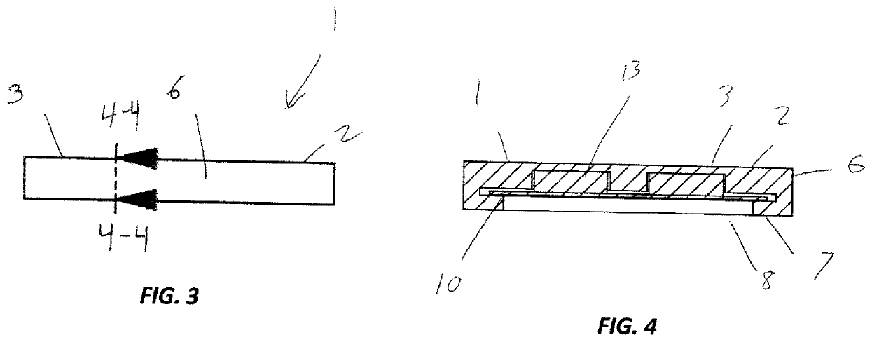

A first embodiment of the present invention is disclosed in FIGS. 1-4. The first embodiment magnetic socket mount 1 comprises a cover 2, a plate 10, and four magnets 13. The cover 2 is cylindrical in shape with a top wall 3 having an outer face 4 and inner surface 5 and a cylindrical side wall 6 having bottom lip 7 encircling an open end 8. The inner surface 5 of the top wall 3 has four cylindrical recessed portions 9. The cylindrical side wall 6 has a groove extending around the inner surface of the cylindrical side wall 6.

The plate 10 is circular and generally corresponds to the circumference of the groove within the cylindrical side wall 6. The plate 10 has a top surface 11 and a bottom surface 12. Four magnets 13 may be positioned on the top surface 11 of the plate 10 by use of an adhesive, locking tab, frictional engagement or other means of securing a magnet to a surface. The recessed portions 9 of the inner surface 5 of the top wall 3 correspond to the shape of the magnets 13. The bottom surface 12 may have an adhesive applied thereon. The plate 10, with the magnets 13, is then fitted within the cover 2 such that the plate 10 is secured in place by the groove. Alternatively the magnets 13 may be inserted into the recessed portions 9 of the inner surface 5 of the top wall 3 and then the plate 10 inserted into the groove. The plate 10, secured by the groove, secures the magnets 13 within the cover 10.

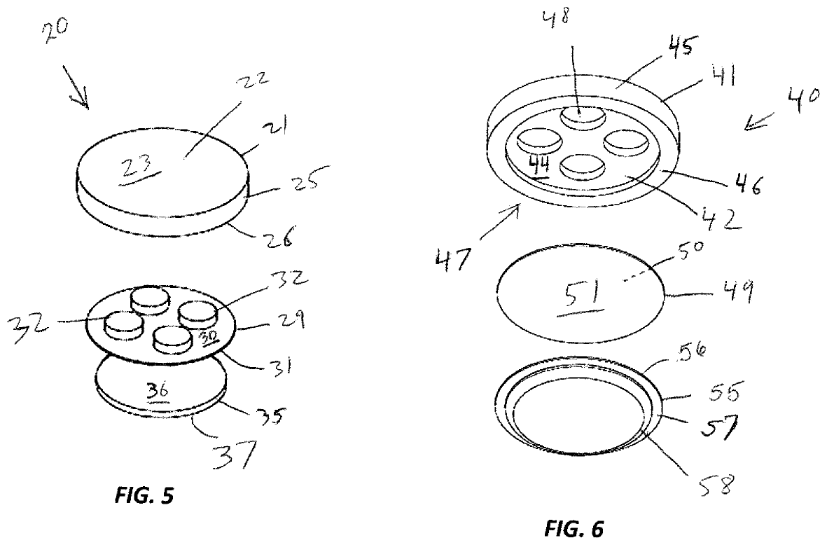

A second embodiment of the present invention is disclosed in FIG. 5. The second embodiment magnetic socket mount 20 is similar in structure to the first embodiment magnetic socket mount 1. The second embodiment magnetic socket mount 20 comprises a cover 21, a plate 29, four magnets 32, and a spacer 35. The cover 21 is cylindrical in shape with a top wall 22 having an outer face 23 and inner surface, and a cylindrical side wall 25 having bottom lip 26 encircling an open end 27. The inner surface of the top wall 22 has four cylindrical recessed portions 28. The cylindrical side wall 25 has a groove extending around the inner surface of the cylindrical side wall 25.

The plate 29 is circular and generally corresponds to the circumference of the groove within the cylindrical side wall 25. The plate 29 has a top surface 30 and a bottom surface 31. Four magnets 32 may be positioned on the top face 30 of the plate 29 by use of an adhesive, locking tab, frictional engagement or other means of securing a magnet to a surface. The recessed portions 28 of the inner surface of the top wall 22 correspond to the shape of the magnets 32. The plate 29, with the magnets 32, is then fitted within the cover 21 such that the plate 29 is secured in place by the groove. Alternatively the magnets 32 may be inserted into the recessed portions 28 of the inner surface of the top wall 22 and then the plate 29 inserted into the groove. The plate 29, secured by the groove, secures the magnets 32 within the cover 21.

The second embodiment magnetic socket mount 20 further comprises a spacer 35 having a top surface 36 and bottom surface 37. The top surface 36 and bottom surface 37 both have adhesive applied. The spacer 35 is fitted within the cover 21 such that the top surface 36 of the spacer 35 adheres to the bottom face 31 of the plate 29. The thickness of the spacer 35 is such that the bottom surface 37 of the spacer 35 extends beyond the bottom lip 26 of the cover 21.

A third embodiment of the present invention is disclosed in FIG. 6. The third embodiment magnetic socket mount 20 is similar in structure to the first embodiment magnetic socket mount 1. The third embodiment magnetic socket mount 40 comprises a cover 41, a plate 49, four magnets 52, and a backing plate 55. The cover 41 is cylindrical in shape with a top wall 42 having an outer face and inner surface 44 and a cylindrical side wall 45 having bottom lip 46 encircling an open end 47. The inner surface 44 of the top wall 42 has four cylindrical recessed portions 48. The cylindrical side wall 45 has a groove extending around the inner surface of the cylindrical side wall 45.

The plate 49 is circular and generally corresponds to the circumference of the groove within the cylindrical side wall 45. The plate 49 has a top surface 50 and a bottom surface 51. Four magnets 52 may be positioned on the top face 50 of the plate 49 by use of an adhesive, locking tab, frictional engagement or other means of securing a magnet to a surface. The recessed portions 48 of the inner surface 44 of the top wall 42 correspond to the shape of the magnets 52. The plate 49, with the magnets 52, is then fitted within the cover 41 such that the plate 49 is secured in place by the groove. Alternatively the magnets 52 may be inserted into the recessed portions 48 of the inner surface 44 of the top wall 42 and then the plate 49 inserted into the groove. The plate 49, secured by the groove, secures the magnets 52 within the cover 41.

The third embodiment magnetic socket mount 40 further comprises a backing plate 55 having a top surface 56 and bottom surface 57. The top surface 56 has an adhesive applied. A micro suction cup 58 is attached to the bottom surface 57. The backing plate 55 is fitted within the cover 51 such that the top surface 56 of the backing plate 55 adheres to the bottom face 51 of the plate 49. The thickness of the backing plate 55 is such that the micro suction cup 58 extends beyond the bottom lip 46 of the cover 41.

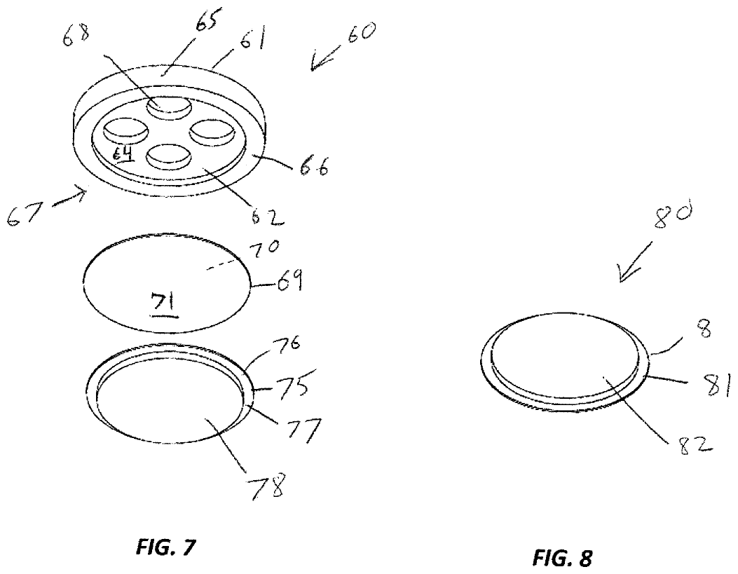

A fourth embodiment of the present invention is disclosed in FIGS. 7-8. The fourth embodiment magnetic socket mount 60 is similar in structure to the first embodiment magnetic socket mount 1. The fourth embodiment magnetic socket mount 60 comprises a cover 61, a plate 69, four magnets 72, a backing plate 75, and a connecting portion 80. The cover 61 is cylindrical in shape with a top wall 62 having an outer face and inner surface 64 and a cylindrical side wall 65 having bottom lip 66 encircling an open end 67. The inner surface 64 of the top wall 62 has four cylindrical recessed portions 68. The cylindrical side wall 65 has a groove extending around the inner surface of the cylindrical side wall 65.

The plate 69 is circular and generally corresponds to the circumference of the groove within the cylindrical side wall 65. The plate 69 has a top surface 70 and a bottom surface 71. Four magnets 72 may be positioned on the top face 70 of the plate 69 by use of an adhesive, locking tab, frictional engagement or other means of securing a magnet to a surface. The recessed portions 68 of the inner surface 64 of the top wall 62 correspond to the shape of the magnets 72. The plate 69, with the magnets 72, is then fitted within the cover 61 such that the plate 69 is secured in place by the groove. Alternatively the magnets 72 may be inserted into the recessed portions 68 of the inner surface 64 of the top wall 62 and then the plate 69 inserted into the groove. The plate 69, secured by the groove, secures the magnets 72 within the cover 61.

The fourth embodiment magnetic socket mount 60 further comprises a backing plate 75 having a top surface 76 and bottom surface 77. The top surface 76 has an adhesive applied. A hook and loop portion 78 is attached to the bottom surface 77. The backing plate 75 is fitted within the cover 71 such that the top surface 76 of the backing plate 75 adheres to the bottom face 71 of the plate 69. The thickness of the backing plate 75 is such that the hook and loop portion 78 extends beyond the bottom lip 66 of the cover 61. A connecting portion 80 is further utilized in association with the fourth embodiment magnetic socket mount 60. The connecting portion 80 comprises a backing plate 81 having a top surface 82 and a bottom surface 83. The top surface 82 has an adhesive applied. A hook and loop portion 84 is attached to the bottom surface 83. The hook and loop portion 78, 84 correspond with one serving as the hook and the other serving as the loop.

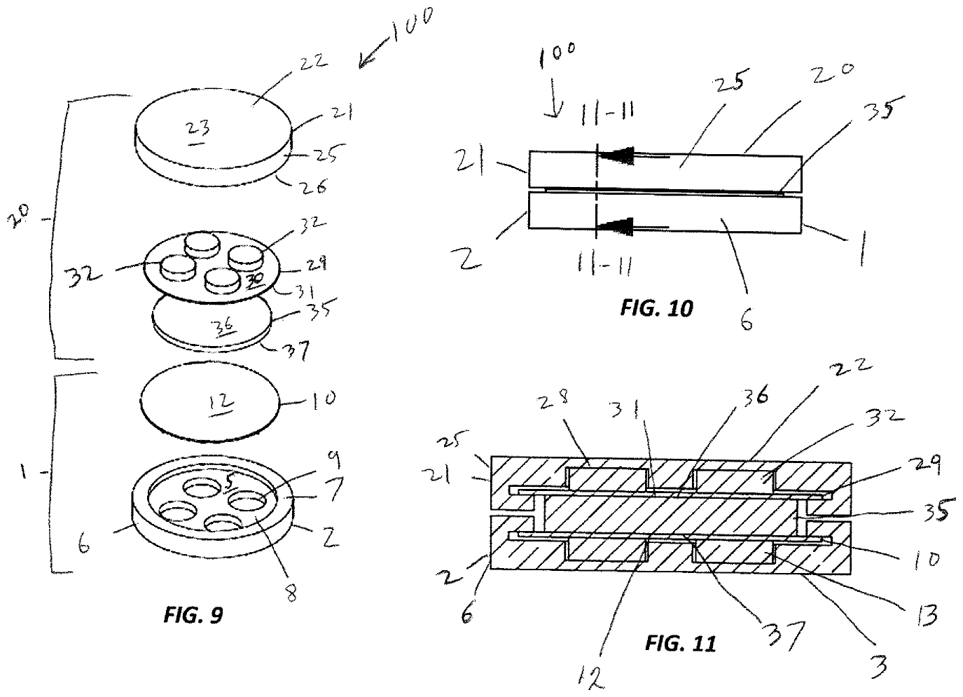

A fifth embodiment of the present invention is disclosed in FIGS. 9-11. The fifth embodiment magnetic socket mount 100 is a combination of the first embodiment magnetic socket mount 1 and the second embodiment magnetic socket mount 20. The bottom surface 12 of plate 10 is adhered to the bottom surface 37 of the spacer 35.

In all embodiments, the cover 2, 21, 41, 61 are preferably constructed of a pliable but firm material such as a rubber. In all embodiments, the plate 10, 29, 49, 69 are preferably constructed of a solid non-pliable material such as metal or a hard plastic. In all embodiments, each magnet 13, 32, 52, 72 are preferably rare earth magnets that have between 15 and 20 pounds of pull. The number and size of magnets within each embodiment may vary.

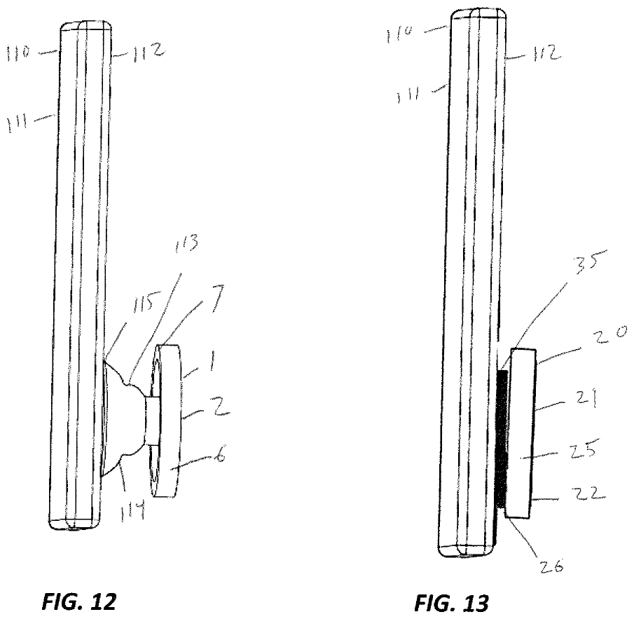

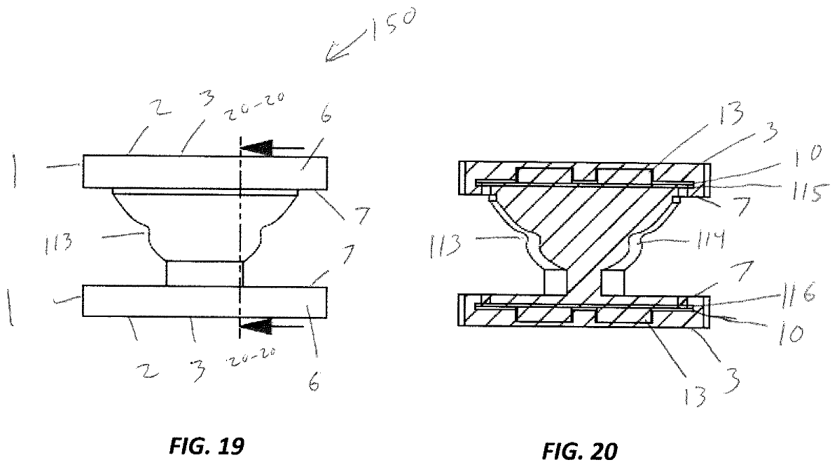

The various embodiments are utilized on phones or other electronic devices and may be used in conjunction with a collapsible mount such as the mount described in U.S. Pat. No. 8,560,031. As seen in FIG. 12, an electronic device 110, such as a phone or tablet, has front face 111 and a back face 112. As illustrated in FIG. 19, a collapsible mount 113 generally has a collapsible portion 114 mounted between a first base 115 and a second base 115. The exterior face of the first base 115 generally has a layer of adhesive which is used to attach the first base 115 to the back face 112 of the electronic device 110 as seen in FIG. 12.

In a first configuration of use as seen in FIG. 12, the first embodiment magnetic socket mount 1 is attached to the second base 116 of the collapsible mount 113. The second base 116 fits within the cover 2 such the bottom lip 7 fits around the second base 116. The circumference of the cover 2 is designed to correspond to the circumference of the second base 116 so the first embodiment magnetic socket mount 1 remains tightly fitted to the collapsible mount 113. Once placed, the first embodiment magnetic socket mount 1 permits the electronic device 110 to be placed on a metallic surface where the electronic device 110 may remain in place due to the magnetic force between the magnets 13 and the metallic surface without a user holding the electronic device 110. The electronic device 110 may be removed from the metallic surface simply by use of force that overcomes the magnetic force. The first embodiment magnetic socket mount 1 does not interfere with the function of the collapsible mount 113.

In a second configuration of use as seen in FIG. 13, the second embodiment magnetic socket mount 20 is attached to the back face 112 of the electronic device 110 via the adhesive on the bottom surface 37 of the spacer 35. In this configuration, the second embodiment magnetic socket mount 20 permits the electronic device 110 to be placed on a metallic surface where the electronic device 110 may remain in place due to the magnetic force between the magnets 32 and the metallic surface without a user holding the electronic device 110. The electronic device 110 may be removed from the metallic surface simply by use of force that overcomes the magnetic force.

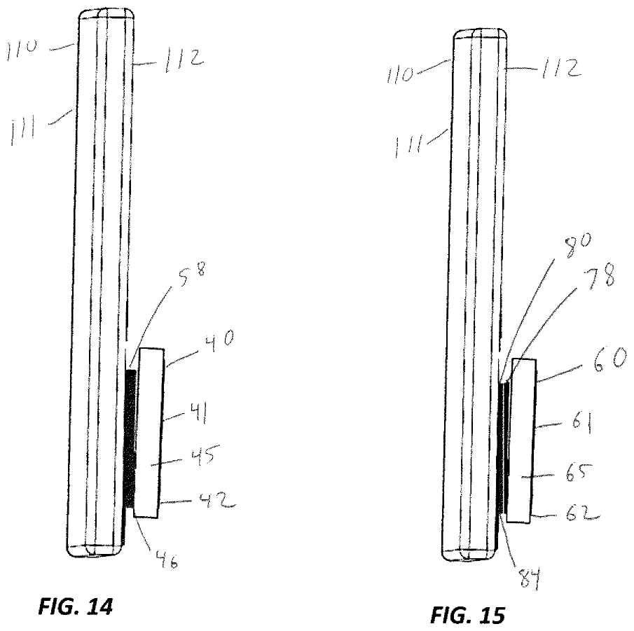

In a third configuration of use as seen in FIG. 14, the third embodiment magnetic socket mount 40 is attached to the back face 112 of the electronic device 110 via the micro suction 58. The third embodiment magnetic socket mount 40 is pushed against the back face 112 such that the micro suction 58 flattens against the back face 112 allowing the third embodiment magnetic socket mount 40 to remain in place. In this configuration, the third embodiment magnetic socket mount 40 permits the electronic device 110 to be placed on a metallic surface where the electronic device 110 may remain in place due to the magnetic force between the magnets 52 and the metallic surface without a user holding the electronic device 110. The electronic device 110 may be removed from the metallic surface simply by use of force that overcomes the magnetic force. In this configuration, the third embodiment magnetic socket mount 40 may be removed from the electronic device 110 by eliminating the suction force of the micro suction 58. The third embodiment magnetic socket mount 40 may be removed entirely or repositioned based on the desired position.

In a fourth configuration of use as seen in FIG. 15, the fourth embodiment magnetic socket mount 60 is attached to the back face 112 of the electronic device 110 via the interaction of the hook and loop portions 78, 84. The connecting portion 80 is adhered to the back face 112 by the adhesive on the bottom surface 83 of the backing plate 81. This permits the hook and loop portion 78 of the cover 61 to be pushed against the hook and loop portion 84 of the connecting portion 80. In this configuration, the fourth embodiment magnetic socket mount 60 permits the electronic device 110 to be placed on a metallic surface where the electronic device 110 may remain in place due to the magnetic force between the magnets 72 and the metallic surface without a user holding the electronic device 110. The electronic device 110 may be removed from the metallic surface simply by use of force that overcomes the magnetic force. In this configuration, the fourth embodiment magnetic socket mount 60 may be removed from the electronic device 110 by pulling the cover 61 off of the connecting portion 80.

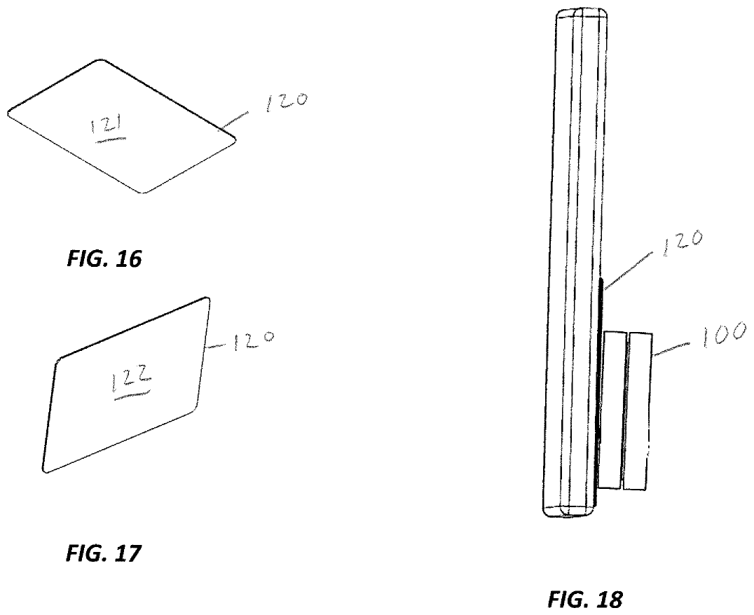

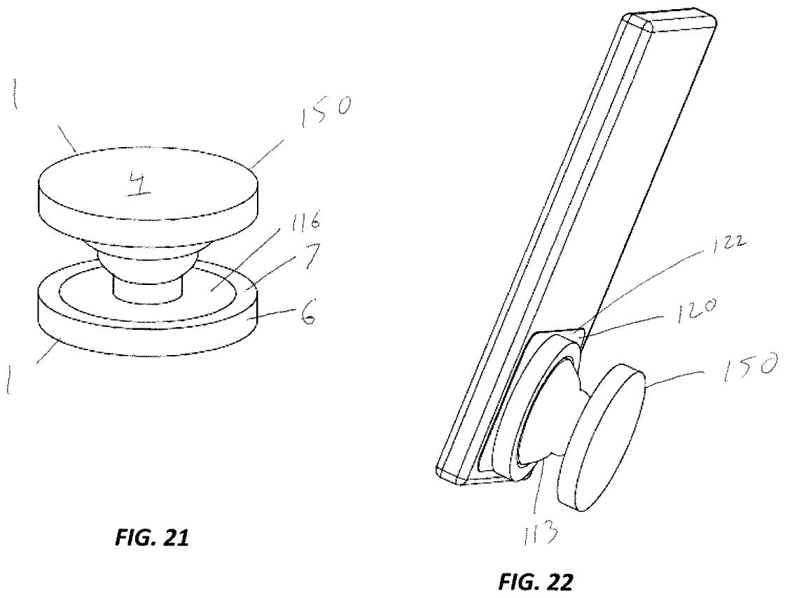

In some configurations as seen in FIGS. 16-22, a metal plate 120 having a bottom surface 121 and a top surface 122 is affixed to the back face 112 of an electronic device 110. The metal plate 120 may be affixed to the back face 112 through an adhesive or other similar means.

In a fifth configuration of use as seen in FIG. 18, the fifth embodiment magnetic socket mount 100 is attached to the top surface 122 of the metal plate 120 via magnetic force. The magnets 13 in the first embodiment magnetic socket mount 1 are attracted to the metal plate 120. This causes the fifth embodiment magnetic socket mount 100 to remain attached to the metal plate 120. In this configuration, the fifth embodiment magnetic socket mount 100 permits the electronic device 110 to be placed on a metallic surface where the electronic device 110 may remain in place due to the magnetic force between the magnets 32 in the second embodiment magnetic socket mount 20 and the metallic surface without a user holding the electronic device 110. The electronic device 110 may be removed from the metallic surface simply by use of force that overcomes the magnetic force. In this configuration, the fifth embodiment magnetic socket mount 100 may be slid along the metal plate 120 to permit the most appropriate use. Further, the fifth embodiment magnetic socket mount 100 may be flipped such that the second embodiment magnetic socket mount 20 may be positioned against the metal plate 120.

A sixth embodiment of the present invention is disclosed in FIGS. 19-22. The sixth embodiment magnetic socket mount 150 comprises first embodiment magnetic socket mount 1 attached to the first base 115 and to the second base 116 of the collapsible mount 113. The attachment of the first embodiment magnetic socket mount 1 to the first base 115 and the second base 116 is the same as described in relation to FIG. 12.

In a sixth configuration of use as seen in FIGS. 19-22, the sixth embodiment magnetic socket mount 150 is attached to the top surface 122 of the metal plate 120 via magnetic force. The magnets 13 in the first embodiment magnetic socket mount 1 positioned around the first base 115 are attracted to the metal plate 120. This causes the first embodiment magnetic socket mount 1 to remain attached to the metal plate 120. The first embodiment magnetic socket mount 1, positioned around the second base 116, and specifically the magnets 13, permits the electronic device 110 to be placed on a metallic surface where the electronic device 110 may remain in place due to the magnetic force between the magnets 13 and the metallic surface without a user holding the electronic device 110. The electronic device 110 may be removed from the metallic surface simply by use of force that overcomes the magnetic force. In this configuration, the sixth embodiment magnetic socket mount 150 may be slid along the metal plate 120 to permit the most appropriate use. The collapsibility of the collapsible mount 113. The sixth embodiment magnetic socket mount 150 may be used by a user to hold the device 110 and may be moved to accommodate a right handed user or left handed user. The sixth embodiment magnetic socket mount 150 may be slid along the metal plate 120 and positioned to allow the electronic device to stand in a portrait orientation or landscape orientation.

In all embodiments the top face of the cover may be imprinted with a logo or other advertisement.

It should be understood that the back face 112 of an electronic device 110 is illustrative and the embodiments may also attach to protective cases then encompass an electronic device.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

1. An electronic device holder comprising:
a mount having a first end and a second end and
a magnetic cover comprising
a cover:
a plate; and
at least one magnet positioned within the cover and secured by the plate;
wherein the magnetic cover is attached to the second end of the mount.

2. An electronic device holder of claim 1 wherein the cover further comprises a lip that fits around the second end of the mount.

3. An electronic device holder of claim 2 wherein the inside surface of the cover has at least one recess that corresponds in size to the at least one magnet.

4. An electronic device holder of claim 2 further comprising a second magnetic cover comprising:
a second cover having an inner surface and an outer surface and a second lip:
a second plate having an top surface and a bottom surface; and
at least one magnet positioned between the top surface of the second plate and the inner surface of the second cover;
wherein the second magnetic cover is attached to the first end of the mount.

5. An electronic device holder of claim 4 further comprising a metallic third plate having first side and a second side wherein the first side of the metallic third plate is capable of sticking to an electronic device.

6. An electronic device holder of claim 5 wherein the metallic third plate is rectangular.

7. An electronic device holder comprising:
a cover having an inner surface and an outer surface:
a plate having an top surface and a bottom surface;
at least one magnet positioned between the top surface of the plate and the inner surface of the cover;
and an attachment device positioned on the bottom surface of the plate.

8. An electronic device holder of claim 7 wherein the attachment device is a double sided adhesive.

9. An electronic device holder of claim 7 wherein the attachment device is a micro suction cup.

10. An electronic device holder of claim 7 wherein the attachment device is a hook and loop fastener.

11. An electronic device holder of claim 7 further comprising a mount having a first end and a second end wherein the attachment device is attached to the second end.

12. An electronic device holder comprising:
a first magnetic cover comprising:
a first cover having an inner surface and an outer surface:
a first plate having an top surface and a bottom surface;
at least one magnet positioned between the top surface of the first plate and the inner surface of the first cover;
a second magnetic cover comprising:
a second cover having an inner surface and an outer surface:
a second plate having an top surface and a bottom surface;
at least one magnet positioned between the top surface of the second plate and the inner surface of the second cover; and
a spacer having a first surface and a second surface wherein the bottom surface of the first plate is attached to the first surface of the spacer and the bottom surface of the second plate is attached to the second surface of the spacer.

13. An electronic device holder of claim 12 wherein the first surface and second surface of the spacer are sticky.

14. An electronic device holder of claim 13 further comprising a metallic second plate having first side and a second side wherein the first side of the metallic second plate is capable of sticking to an electronic device.

15. An electronic device holder of claim 14 wherein the metallic second plate is rectangular.
